(19) United States
(12) Patent Application Publication
(10) Pub. No.: US 2008/0214216 A1
(43) Pub. Date: Sep. 4, 2008

(54) MOBILE NOTIFICATION SYSTEM

(76) Inventors: Michael J. Bragg, Minnetonka, MN (US); Matt Armstead, Powell, OH (US); Simon Wiltshire, Minnetonka, MN (US)

Correspondence Address: POLSINELLI SHALTON FLANIGAN SUELTHAUS PC, 700 W. 47TH STREET, SUITE 1000, KANSAS CITY, MO, 64112-1802, US

(21) Appl. No.: 12/040,534

(22) Filed: Feb. 29, 2008

Related U.S. Application Data
(60) Provisional application No. 60/892,752, filed on Mar. 2, 2007.

(51) Int. Cl. H04Q 7/20

(52) U.S. Cl. 455/466

(57) ABSTRACT

A mobile notification system and method is provided for notifying a customer via a telecommunication device when a desired good or service is made available. A customer of an establishment enters customer data into a mobile notification system via a client computer to receive notification from the establishment via the telecommunication the desired good or service is available. The client computer then sends a notification to the telecommunication device of the customer when the desired good or service is available. The client computer periodically sends customer data to a server for storage in a database. The server is responsive to a reporting request received from an authorized user of the server to retrieve customer data from the database to generate various reports.

### REFERENCE TO RELATED APPLICATION

This patent application claims priority from U.S. provisional patent application Ser. No. 60/892,752, filed on Mar. 2, 2007 and is herein incorporated by reference in its entirety.

### FIELD

The present document relates to a mobile notification system, and more particularly to a mobile notification system that permits a customer to receive notice of the availability of a desired service over a mobile telecommunication device or the like.

### BACKGROUND

With the development of new mobile functionality, services and devices, consumers are adopting these capabilities faster and faster such that mobile phones are now considered the must have technology of the twenty first century. Accordingly, mobile phones are becoming an essential part of life. Given the statistics, adoption rates, increased functionality and self-evident uses for mobile phones, there is a significant opportunity for consumer driven industries to utilize this technology to enhance the services they offer consumers.

### SUMMARY

In one aspect, a system for registering a user to receive a notification of an available service via a telecommunication device is provided. The system may include a display component for displaying one or more input forms to a user. The system may also include a storage component responsive to registration data received from the user via the input forms in order to store registration data in a local database. The registration data identifies a telephone number for the telecommunication device. The system may further include a transfer component responsive to the registration data received from the user via the input forms to transfer registration data to a central database for storage as well as an assignment component responsive to the storing of the registration data in order to add the user to a notification queue. The notification queue may list one or more users in a sequence based on an order in which corresponding registration data was added to the local database. In addition, the system may include a notification component that is responsive to input received from a local administrator regarding the availability of a desired service in order to send a notification to a next user in the sequence of the one or more users in the notification queue via a corresponding telephone number identified from the stored registration data.

According to another aspect, a system for online reporting is provided. The system may include an online reporting component that allows a local service provider or commissioning entity to view customer survey information based on registration data collected from a user during a registration process.

Additional objectives, advantages and novel features will be set forth in the description which follows or will become apparent to those skilled in the art upon examination of the drawings and detailed description that follows.

### BRIEF DESCRIPTION OF THE DRAWINGS

FIGS. 1A and 1B are block diagrams of a mobile notification system according to aspects of the present invention.

FIGS. 1C and 1D are screen views of a notification queue according to aspects of the mobile notification system.

FIG. 2A is a block diagram of an Oncall application according to one aspect of the mobile notification system.

FIGS. 2B-2T are screen views of various input forms.

FIG. 3A is a flow chart illustrating a method for collecting registration data from a customer via a client computer.

FIG. 3B shows screen views of incentive awards.

FIG. 3C shows screen views of a survey form.

FIG. 4A is a flow chart illustrating a method for implementing mobile notification and satisfaction reporting according to an aspect of the mobile notification system.

FIG. 4B shows screen views of email incentive awards.

Corresponding reference characters indicate corresponding elements among the several views. The headings used in the figures should not be interpreted to limit the scope of the figures.

### DETAILED DESCRIPTION

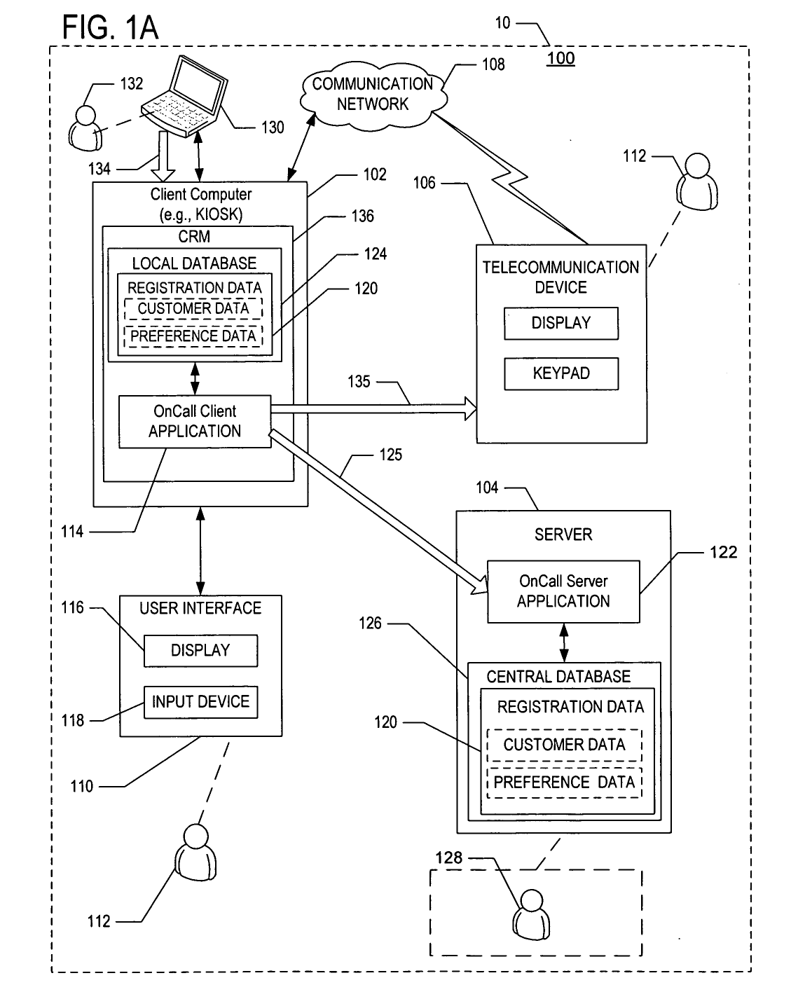

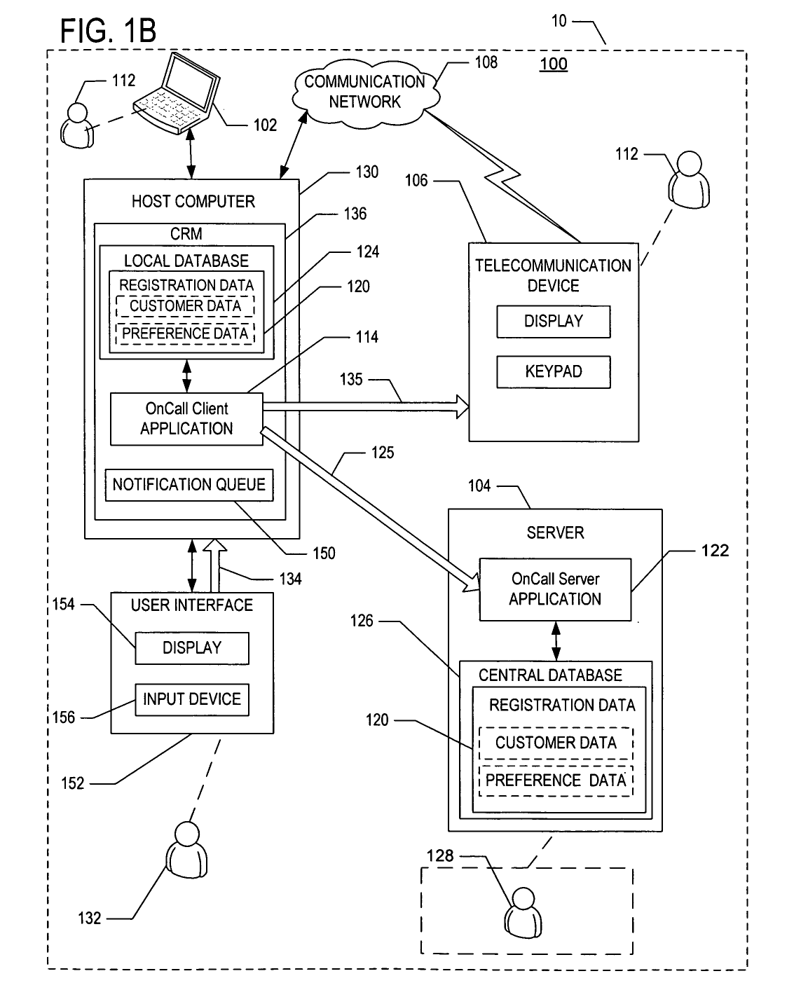

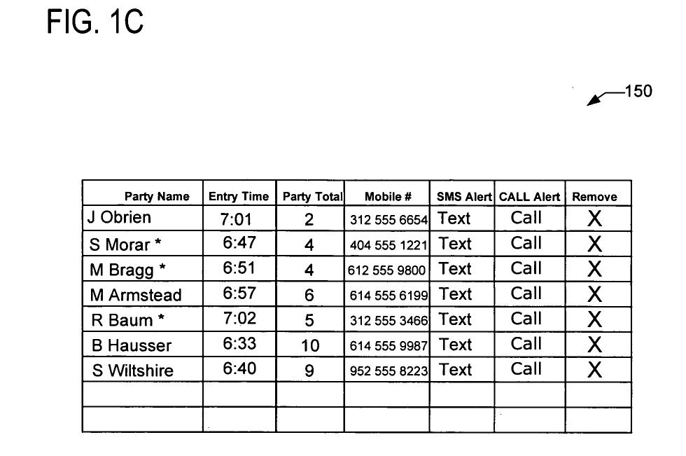

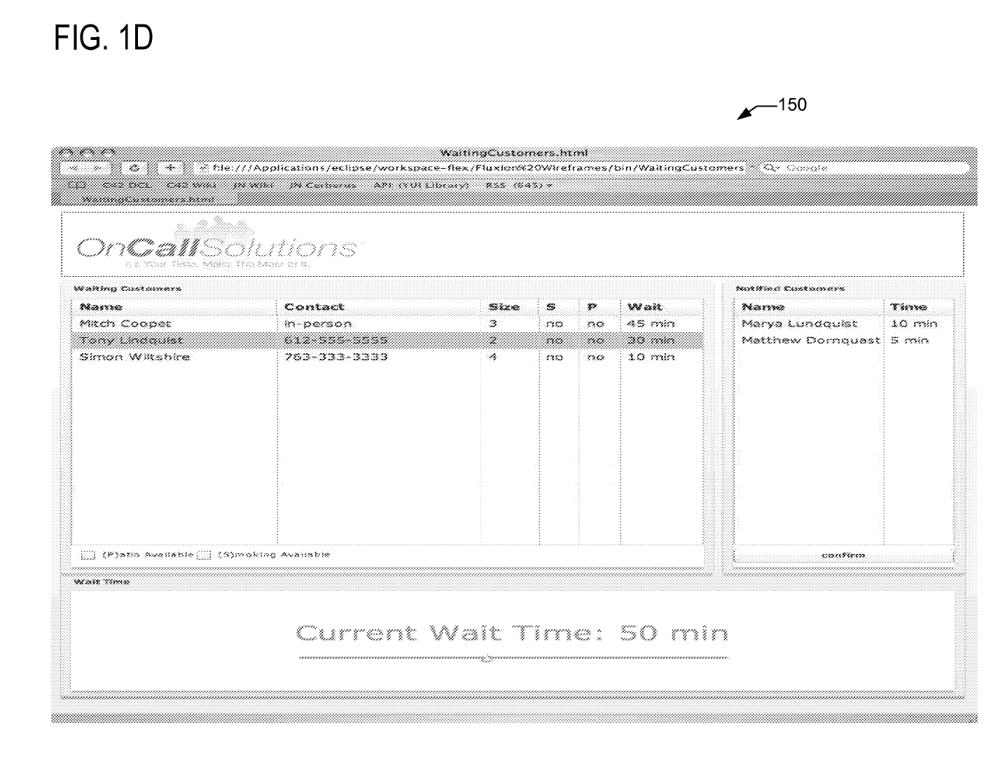

Referring to the drawings, a system and method for implementing a mobile notification system is generally indicated as 10 in FIG. 1A. FIG. 1A is a block diagram illustrating the various components of the mobile notification system 10 in an operating environment 100 in which aspects of the mobile notification system 10 may be implemented. In this instance, FIG. 1A diagrammatically shows cross network communication between a client computer 102, a server 104, and a telecommunication device 106 in the operating environment 100. More specifically, aspects of the mobile notification system 10 are described in the context of the client computer 102 being communicatively linked to the server 104 and the telecommunication device 106 such that data can be exchanged between the client computer 102 and server 104 and between the client computer 102 and the telecommunication device 106.

According to one aspect, the client computer 102 communicates with the server 104 and telecommunication device 106 via a data communication network 108. In this example, the data communication network 108 may be the Internet (or the World Wide Web) that facilitates the transfer of data between the client computer 102 and the telecommunication device 106. However, the teachings of the mobile notification system 10 can be applied to any data communication network. In this example, the client computer 102 and the telecommunication device 106 may communicate data among themselves using a Short Messaging Service (SMS), which is a protocol commonly used to send text messages between client computers and telecommunication devices. Alternatively, the client computer 102 and telecommunication device 106 can communicate data among themselves using a Wireless Application Protocol (WAP) which is a protocol commonly used to provide Internet service to digital mobile phones and other wireless terminals. The client computer 102 and the server 104 may communicate data among themselves using a Hypertext Transfer Protocol (HTTP), which is a protocol commonly used on the Internet to exchange information between clients and servers. According to one aspect of the mobile notification system 10, the client computer 102 is a kiosk located in a particular service establishment such as a restaurant, an automotive repair shop, a hair salon, a pharmacy, or any other establishment that provides a service or good for which the customer may be required to wait a period of time before receiving the good or service.

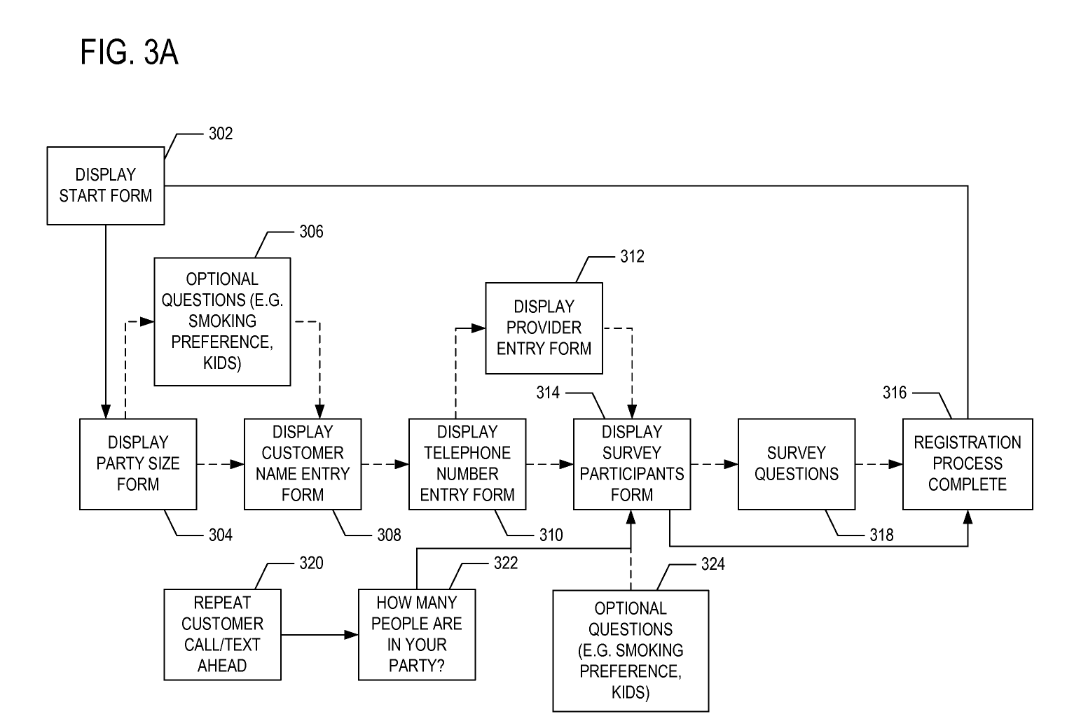

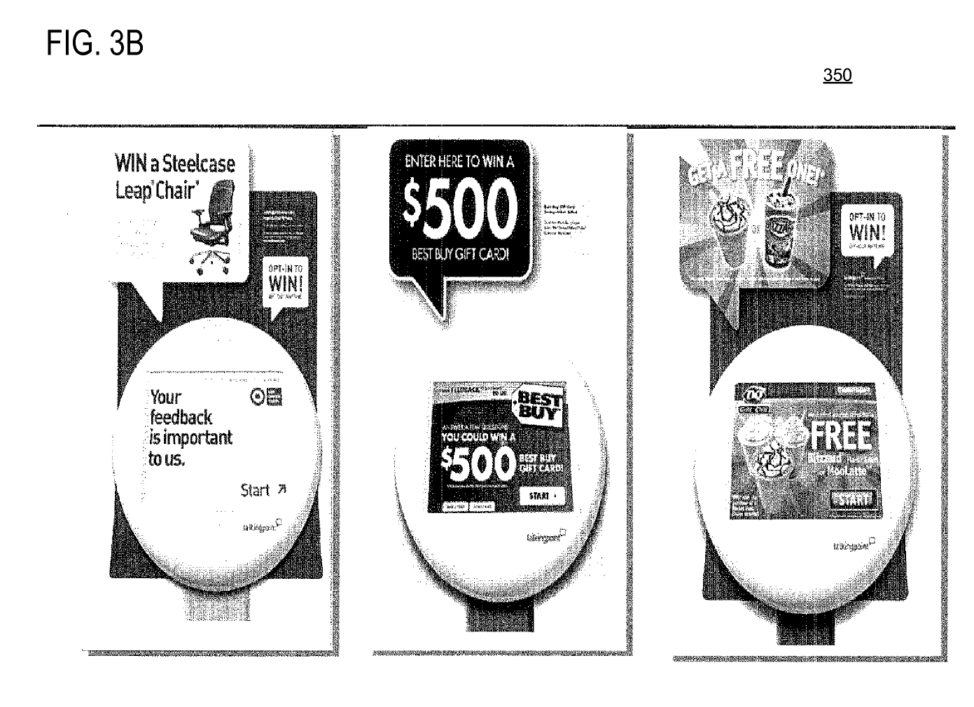

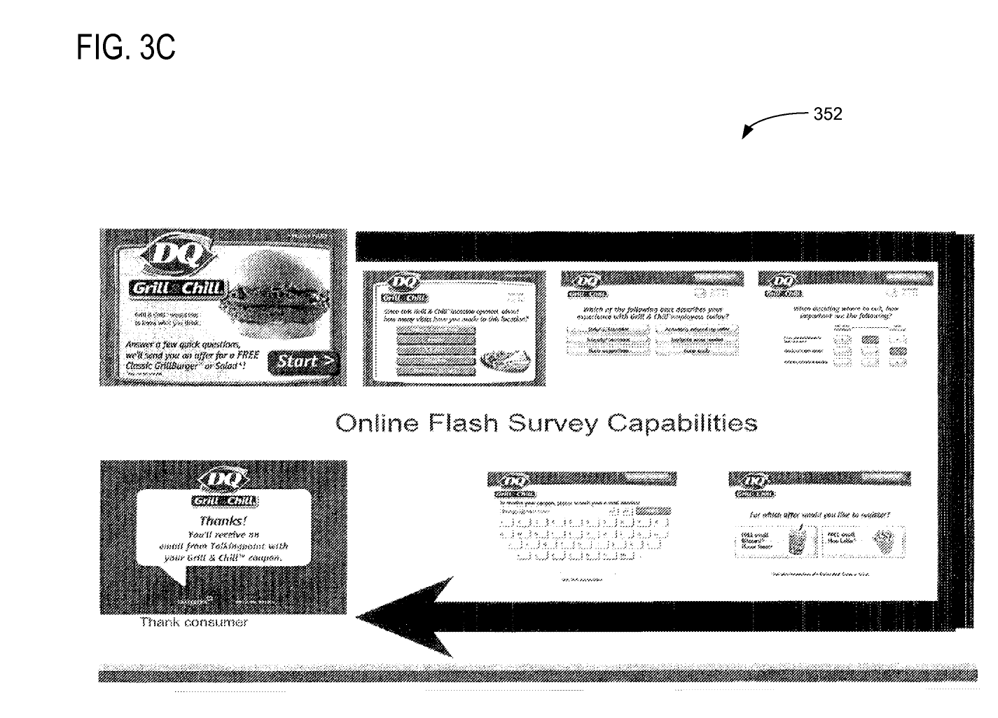

A user-interface (UI) 110 operatively coupled to the client computer 102 enables a customer, or user, 112, of the client computer 102 to interact with an OnCall client application (client application) 114 to receive a notification regarding the availability of a desired service or good. According to one aspect, the UI 110 includes a display 116, such as a monitor, for displaying one or more input forms, and an input device 118, such as a keyboard or a pointing device (e.g., a mouse, trackball, pen, or touch screen), for entering registration data 120 for a particular user 112 into the one or more input forms (e.g., screen shots shown in FIGS. 3B-3F). The input forms allow a user 112 to input registration data. Registration data 120 comprises customer data such as contact information and customer preference data such as a smoking preference (e.g., seating in a smoking or a non-smoking section). For example, the customer 112 of a restaurant can interact with an input form via the UI 110 to initiate a registration process to receive a notification of the availability of a table via their telecommunication device 106.

A local database 124 stores registration data 120 including customer data and customer preference data entered by the user 112 via the various input forms. According to another aspect, the client application 114 periodically communicates with an OnCall server application (server application) 122 to transfer or upload customer preference data and/or customer data (i.e., registration data 120) from the local database 124 of the client computer 102 to the server 104, as indicated by reference character 125. The server application 122 stores the uploaded registration data 120 in a central database 126. Thereafter, the registration data 120 can be used and/or accessed by an administrator 128 of a commissioning entity to generate customer satisfaction reports such as described in U.S. Patent Application Publication No. 2006/0053058, which is incorporated herein by reference in its entirety. The commissioning entity is, for example, a central office or headquarters of a restaurant chain.

The client computer 102 can be further communicatively linked to a workstation computer 130 such that a local administrator 132 (e.g., host or hostesses) can view party information for customers in a notification queue 150 (See FIG. 1C) that are waiting to be seated.

According to one aspect, the notification queue 150 comprises registration data 120 such as the party name, a time the registration was completed, party size information, the telephone number, and whether to call and/or text the customer. The notification queue 150 may list registration data 120 for customers in a chronological sequence based on the time each customer completed the entry of their registration data 120. The notification queue 150 may further sort the listed registration data for customers based on other registration data such as party size. The notification queue 150 is also configured to remove customer registration data from the notification queue 150 in response to input received from the local administrator 132 identifying one or more parties to remove.

Referring back to FIG. 1A, the local administrator 132 receives updates regarding the status of a service or good. For example, in a restaurant implementation, the local administrator receives status of the availability of tables from employees. Thereafter, the local administrator 132 generates a notification request, as indicated by reference character 134, via the work station 130 when a table is available for seating a particular customer 112. The client application 114 then sends a notification, as indicated by reference character 135, to the telecommunication device 106 of that particular customer.

FIG. 1B depicts another aspect of the mobile notification system 10 where the host computer 130 comprises the client application 114, the local database 124 storing the registration data, and the notification queue 150. In this aspect, the client computer 102, or kiosk, is primarily a data entry terminal and is used by the customer 112 to enter registration data 120.

In this aspect, the local administrator 132 can also interact with a user-interface (UI) 152 that is operatively coupled to the host computer 130 to enable a customer, or user, 112 to receive a notification 135 regarding the availability of a desired service or good. For example, in response to a telephone call from a customer the administrator 132 can use the UI 152 to enter registration data 120 for a particular customer via the one or more input forms (e.g., screen shots shown in FIGS. 3B-3F).

The local administrator 132 may also use the UI 152 to generate the notification request 134 when the desired service is available for particular customer 112. The client application 114 then sends the notification 135 to the telecommunication device 106 of that particular customer 112. The UI 152 can operate substantially the same as the UI 110. For example, the UI 152 includes a display 154, such as a monitor, for displaying one or more input forms, and an input device 156, such as a keyboard or a pointing device (e.g., a mouse, trackball, pen, or touch screen), for entering registration data 120 for a particular user 112 into the one or more input forms.

As a result, aspects of the mobile notification system 10 provide an improved notification system that allows customers to receive notification from farther distances and to eliminate the need to carry potentially unsanitary notification devices (e.g., pagers) that have been handled by multiple individuals. Aspects of the mobile notification system 10 also provide the administrator 128 of the particular commissioning entity the ability to readily receive customer data and customer preference data.

Although the mobile notification system 10 is described herein in the context of registration via a mobile phone, it is contemplated that the principles of the mobile notification system 10 can be applied to other telecommunication devices 104 such as personal digital assistants (PDAs), smart phones and any other type of interactive wireless communication devices. Moreover, although the server application 122 is illustrated in FIGS. 1A and 1B as being located on the same server computer 104 that maintains the central database 126, it is contemplated that the server application 122 can be executed on a different server that is communicatively connected to the central database 126.

For purposes of illustration, examples of the mobile notification system 10 are described herein in reference to providing notifications to customers desiring seating at a restaurant. However, the principles of the mobile notification system 10 need not be limited to a registration process for seating customers at a restaurant or eatery, but can be used in connection with any service where mobile notification can be utilized. For example, the mobile notification system 10 can be used in connection with a pharmacy service such that the customer 112 need not wait within the confines of the pharmacy to receive notification of the availability of a requested prescription. As another example, a particular manufacturer of goods may have a client computer located within a particular retail establishment such that the customer 112 can elect to receive mobile notification of promotional or sales events at that particular retailer regarding the manufacturer's goods.

The operating environment 100 illustrated in FIGS. 1A and 1B may include a general purpose computing device (e.g., client computer 102 or host computer 132), such as a computer executing computer-executable instructions. The computing device typically has at least some form of computer readable media (e.g., CRM 136). Computer readable media 136 may include volatile media, nonvolatile media, removable media and non-removable media, may also be any available medium that may be accessed by the general purpose computing device. By way of example and not limitation, computer readable media 136 may include computer storage media and communication media. Computer storage media may further include volatile, nonvolatile, removable and non-removable media implemented in any method or technology for storage of information such as computer readable instructions, data structures, program modules or other data. Communication media may typically embody computer readable instructions, data structures, program modules, or other data in a modulated data signal, such as a carrier wave or other transport mechanism and include any information delivery media. Those skilled in the art will be familiar with the modulated data signal, which may have one or more of characteristics set or changed in such a manner that permits information to be encoded in the signal. Wired media, such as a wired network or direct-wired connection, and wireless media, such as acoustic, radio frequency, infrared, and other wireless media contemplated by the mobile notification system 10, are examples of communication media discussed above. Combinations of any of the above media are also included within the scope of computer readable media discussed above. The client computer 102 and the host computer 130 may include or be capable of accessing computer storage media in the form of removable and/or non-removable, volatile and/or nonvolatile memory. A user may enter commands and information into the client computer 102 through the input devices 118, 154. Other input devices (not shown) may also be connected to the computing device. The client computer 102 and host computer 130 may also operate in a networked environment using logical connections to one or more remote client computers.

Although described in connection with operating environment 100, other embodiments of the mobile notification system 10 are operational with numerous other general purpose or special purpose computing system environments or configurations. The operating environment 100 is not intended to suggest any limitation as to the scope of use or functionality of the various embodiments of the mobile notification system 10. Moreover, the operating environment 100 should not be interpreted as having any dependency or requirement relating to any one or combination of components illustrated in the operating environment 100. Examples of well known operating systems, environments, and/or configurations that may be suitable for use in embodiments of the mobile notification system 10 include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

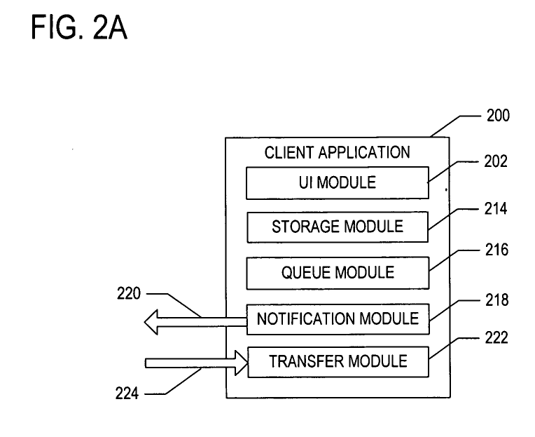

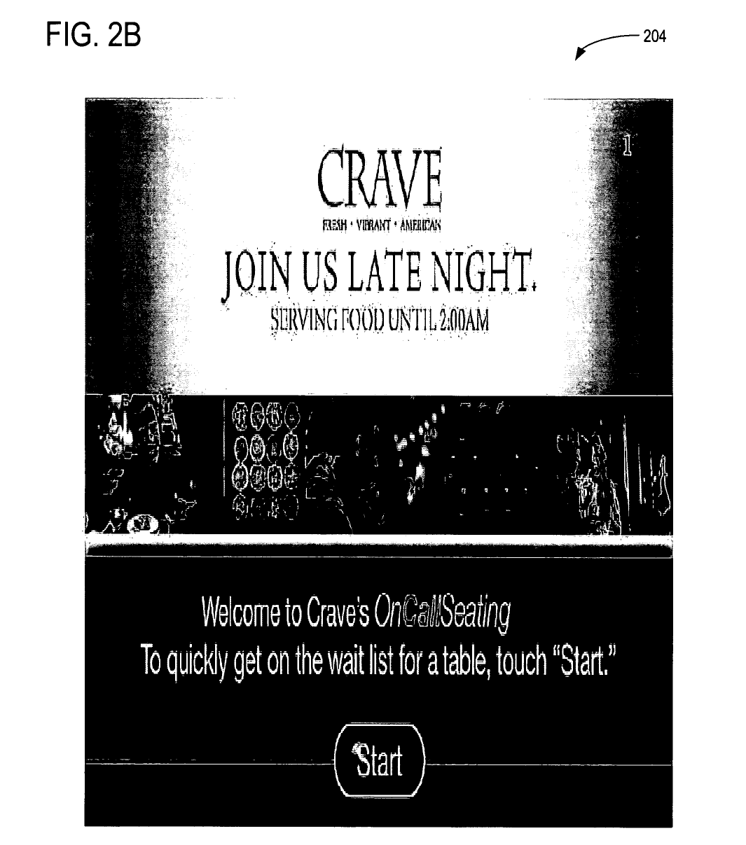

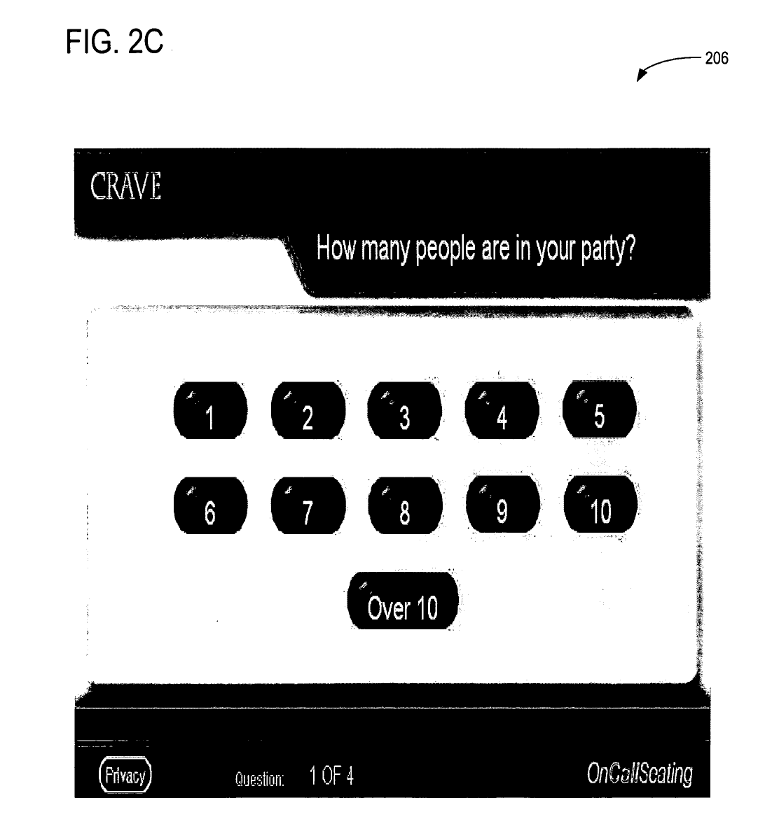

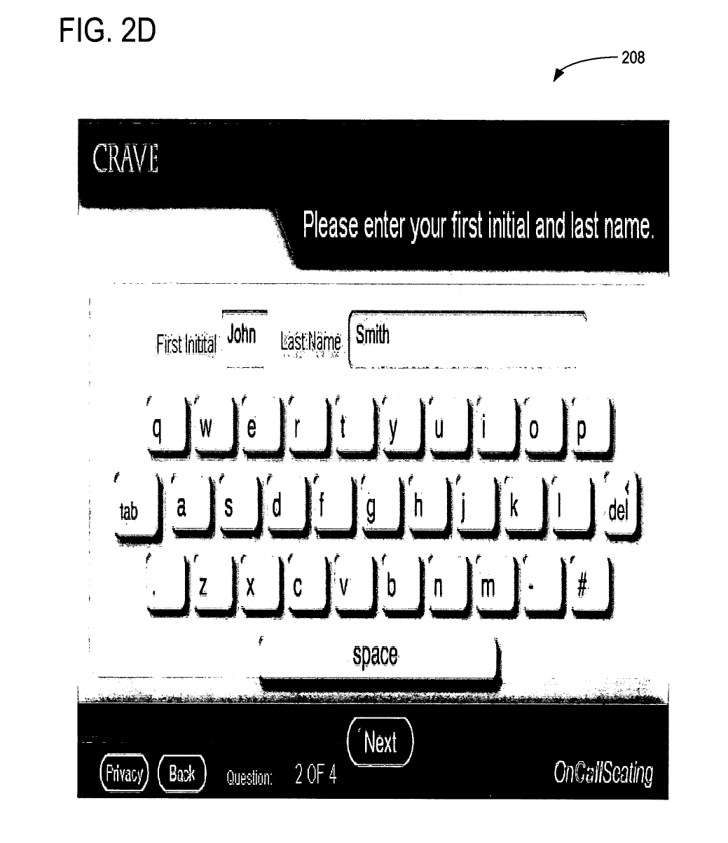

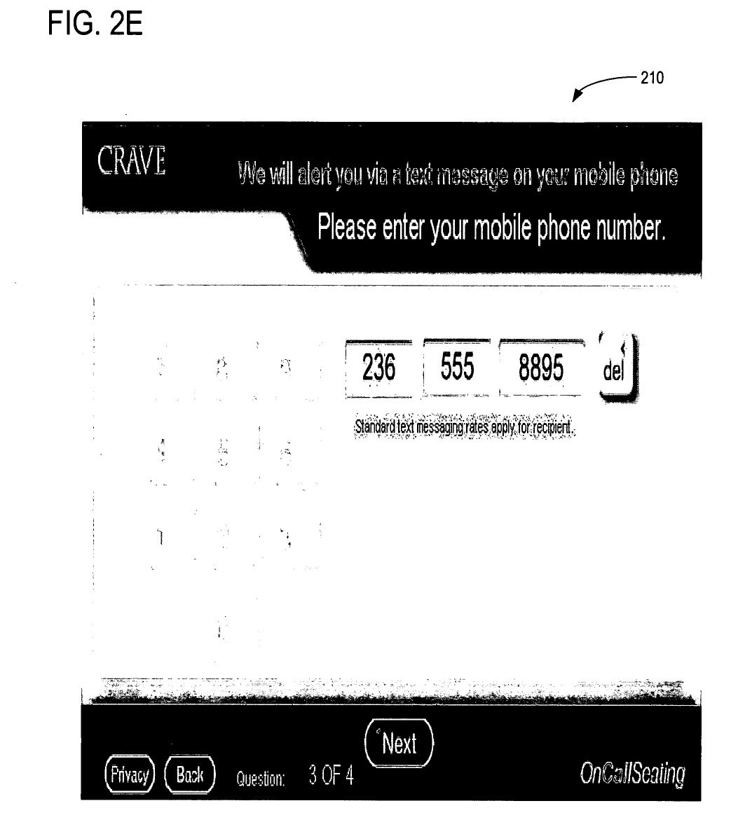

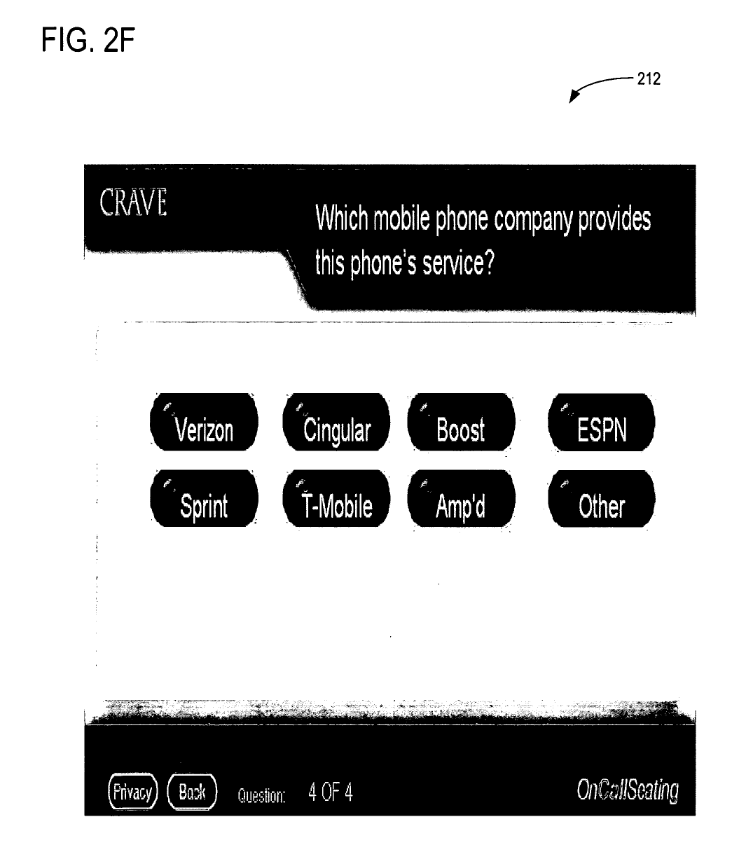

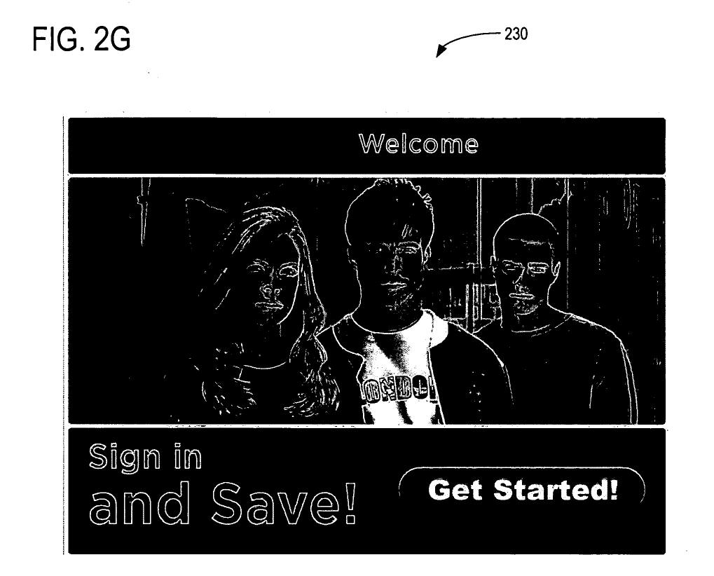

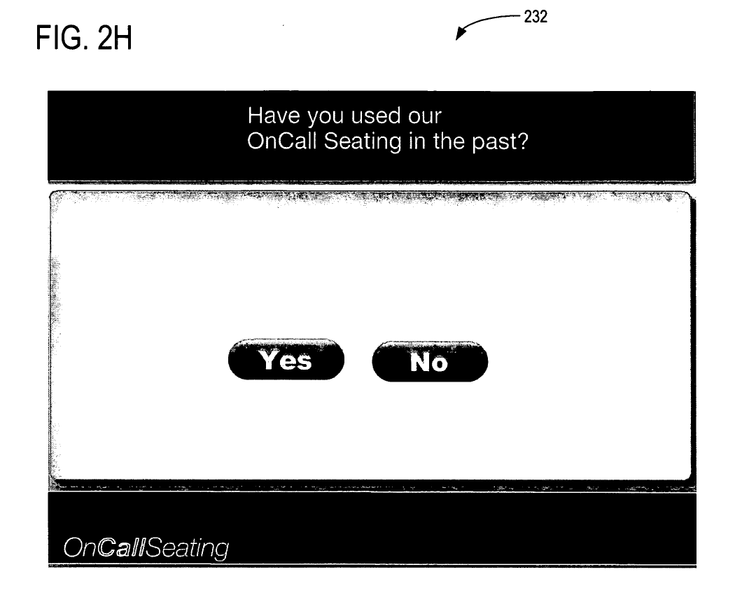

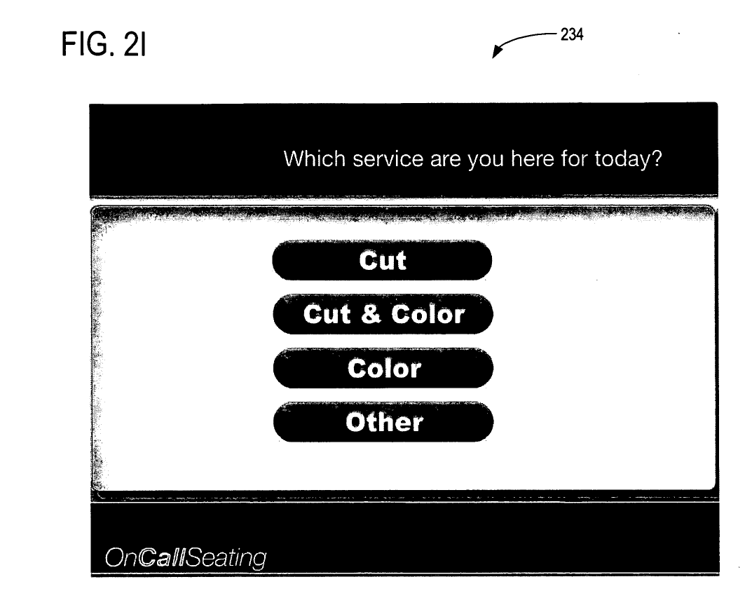

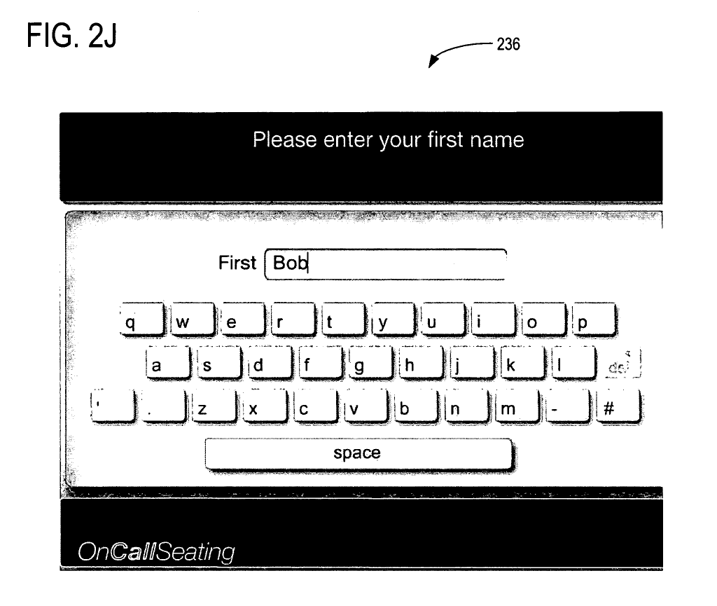

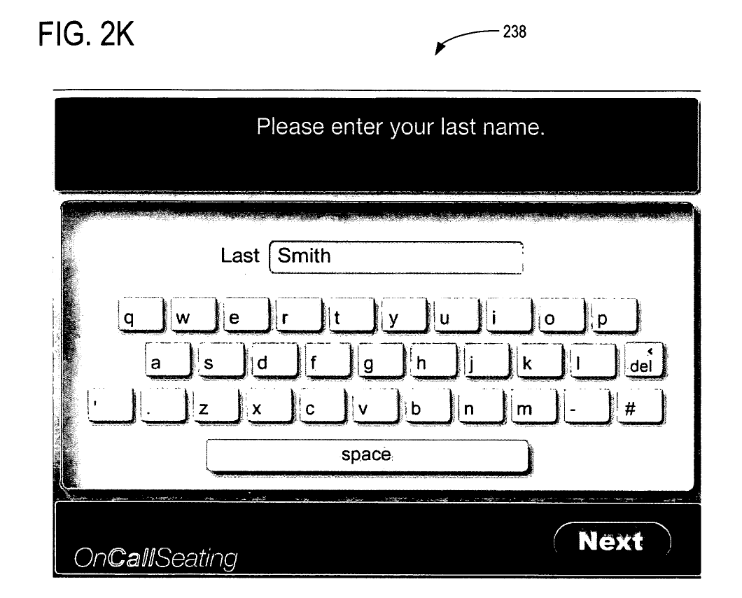

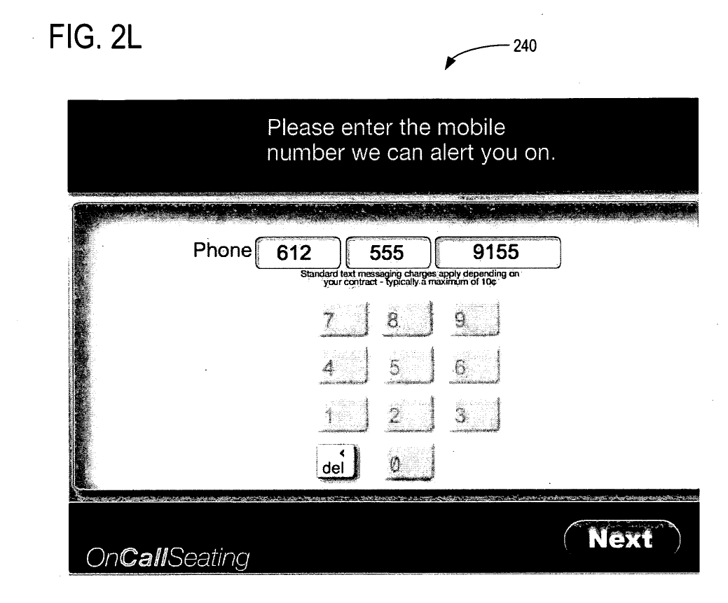

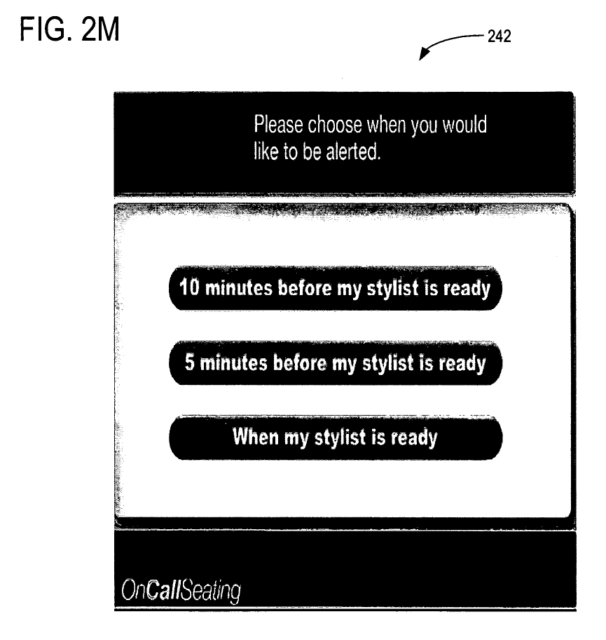

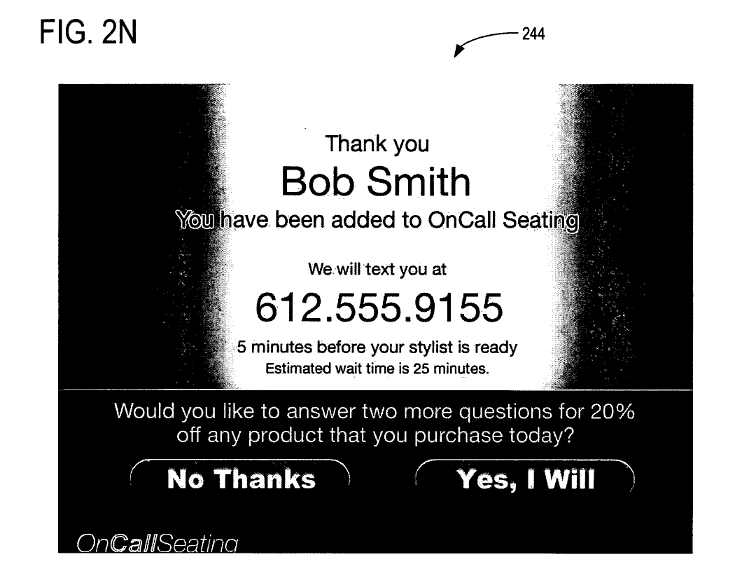

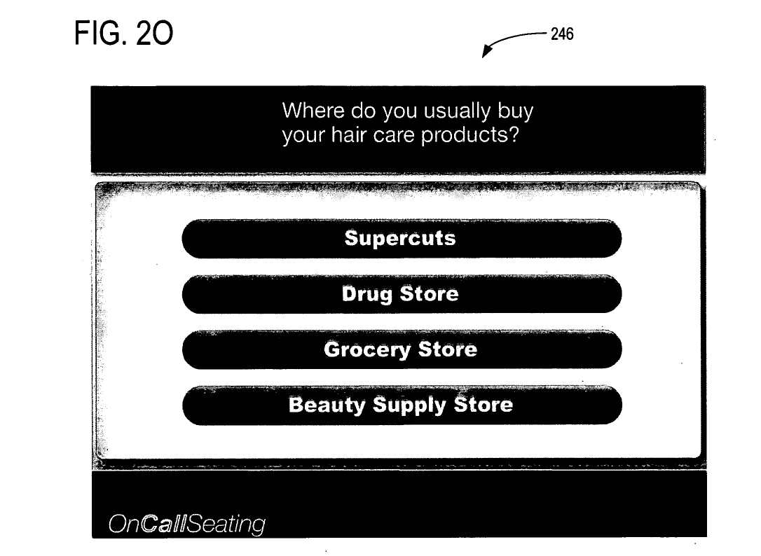

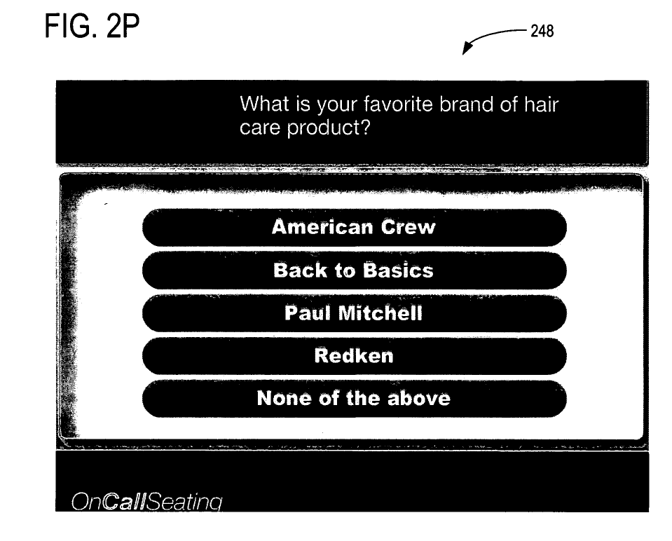

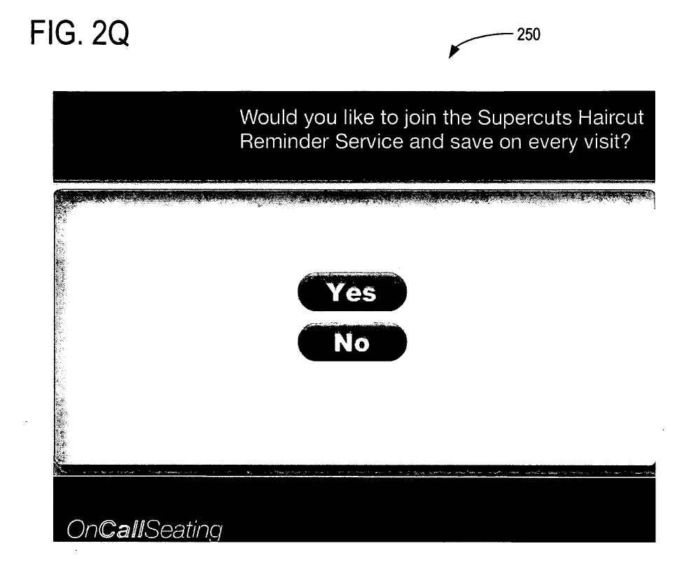

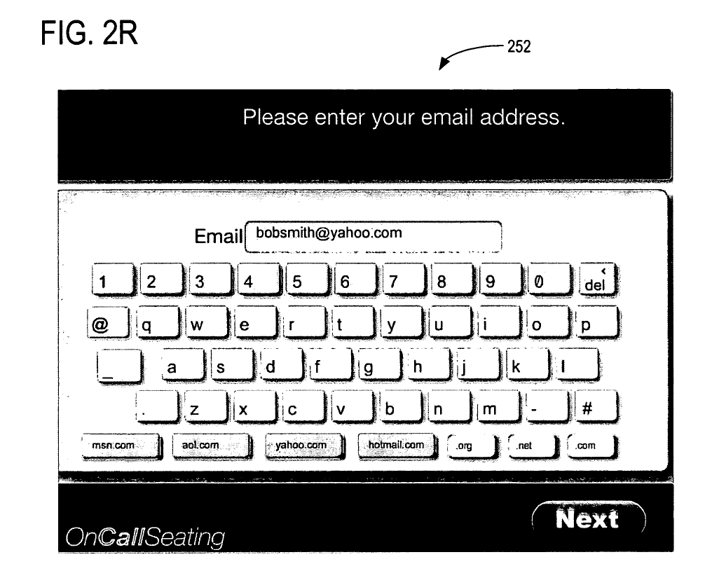

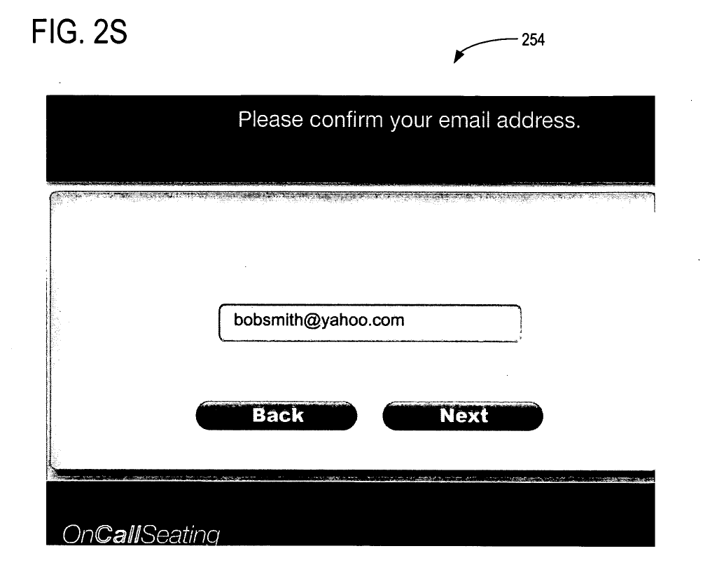

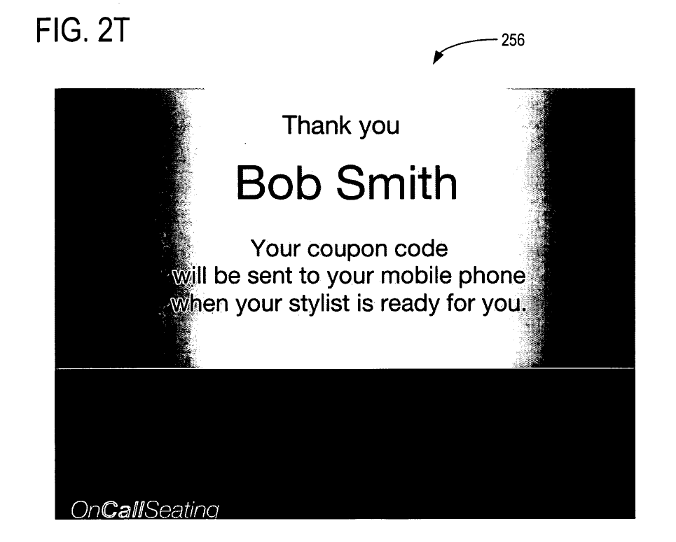

FIG. 2A depicts an exemplary client application 200 (e.g., client application 114) according to one aspect of the mobile notification system 10. The client application 114 comprises modules that enable the client computer 102 to receive registration data from a customer 112 and to notify the customer regarding the status of a desired good or service.

A user-interface (UI) module 202 generates a start form 204, such as depicted in the screen view shown in FIG. 2B, to display via the display 116 in response to the client application 114 being executed on the client computer 102. The user 112 of the client computer 102 selects, for example, a start option button on the start form 204 to initiate a registration process to receive a notification 135 of the availability of a table for seating at a restaurant via the telecommunication device 106.

The user-interface (UI) module 202 generates a party size entry form 206, such as depicted in FIG. 2C, to display on the display 116 in response to the customer 112 selecting the start button. The customer 112 can interact with the party size entry form 206 to enter the total number of people in his or her party. According to one aspect, if the total number of people in the party exceeds a predetermined maximum value (e.g., 10), the UI module 202 generates a message for display on the display 116 that instructs the customer 112 to see the hostess. Alternatively, if the total party number entered by the customer 112 is less than the predetermined maximum value (e.g., 4), the UI module 202 generates a customer name entry form 208, such as depicted in FIG. 2D, to display on the display 116 in response to the customer 112 selecting a next option button on the party size entry form 206. The customer 112 then interacts with the customer name entry form 208 to enter his or her name.

According to another aspect, the UI module 202 generates a telephone number entry form 210, such as depicted in FIG. 2E, on the display 116 in response to the customer 112 entering a name and selecting a next option button on the customer name entry form 208. The customer 112 can interact with the telephone number entry form 210 to enter his or her mobile telephone number.

According to another aspect, the UI module 202 optionally generates a carrier name entry form 212, such as depicted in FIG. 2F to display on the display 116 in response to the customer 112 entering a telephone number and selecting a next option button displayed on the telephone number entry form 210. For example, in order to provide a notification to the customer 112 such as a short message service (SMS) alert (e.g., text message) notifying the customer 112 a table is ready, it may be necessary to know the carrier. If the customer 112 is not using a supported wireless carrier, the client application 114 can be configured to follow an alternative protocol such as initiating a digital call to the customers phone to deliver a prerecorded voice message rather than sending a SMS alert.

According to another aspect, the UI module 202 generates a registration complete message and an incentive message for display on the display 116 in response to the customer 112 entering a carrier name and selecting a next option button on the customer carrier name entry form 212. The incentive message may be, for example, a message asking the customer 112 if he or she would like to receive an incentive award (e.g., free desert, coupons, discounts, etc.) by completing a survey. If the customer selects a “NO” or “NO THANKS” option button associated with the incentive message the UI module 202 again displays the start form 204 or home screen on the display 116.

In the alternative, the UI module 202 generates a survey form for receiving customer preference data 122 in response to the customer 112 selecting, for example, a “YES” or “OK” option button associated with the incentive message. The survey form 352 is a type of input form that allows the customer 112 to answer yes or no questions such as “Did you enjoy your previous dining experience?”; “Were you acknowledged and greeted promptly?” Other survey questions may include multiple choice questions such as: “What is your favorite night to dine out?”; “Are you here for business or pleasure?”; and/or “What brought you here tonight?” Possible answers to “What is your favorite night to dine out?” may include a listing of the days of the week. As another example, possible answers to “What brought you here tonight?” may include “Escape from/after work with friend,” “Family Adventure,” and/or “Mix Business with Pleasure.”

FIGS. 2G-2T depict example screen view of forms 230-256 that may be generated by the UI module 202 for an implementation of the mobile notification system 10 in a hair salon.

In yet another aspect, the UI module 202 generates an email entry form (e.g. see input form 254) to display that allows the customer 112 to enter an email address in order to receive incentive awards such as coupons via email.

A storage module 214 stores the various types of registration data 120 received via the various input forms and stores the registration data 120 in the local database 124. In this aspect, the registration data 120 includes customer data such as party size, customer or party name, customer mobile telephone number, email address, provider name and/or customer survey information. Notably customer preference data may also be included in the survey information.

An queue module 216 adds a customer name and telephone number to the notification queue 150 that lists customers in a sequence based on a time the corresponding registration data was added to the local database 124. According to one aspect, when a table becomes available, the local administrator 132 can select or designate a customer to be seated based on party size and/or a time the customer's registration data was added to the notification queue 150. It is also contemplated that the queue module 216 can be figured to automatically identify the customer 112 to be seated based on party size and/or a time the customer's registration data was added to the notification queue 150.

According to another embodiment, the queue module 216 is configured to sort the registration data 120 according to various data and/or parameters. For example, in a restaurant implementation, the queue module 216 is responsive to input from the local administrator 132 to sort customers in the queue 150 according to an amount of time the customer has been waiting, the number of children in party, a loyalty score, or any other recorded parameter. The loyalty score is a parameter that identifies whether a particular customer is a return customer and, if so, how frequently the customer returns. For example, the higher the score, the more loyal the customer.

According to one aspect, the queue module 216 is configured to determine an estimated total wait time for customer that will be displayed along with the queue 150 on the display 116. (See FIG. 1D.) This allows the administrator to readily inform new customers of an expected wait time for the service. According to another aspect, the queue module 216 is configured to highlight customers in the queue 150 that have a loyalty score that exceed a threshold value.

Notably, the type of registration data or parameters displayed in the queue 150 is configurable based on the particular service being offered. For example, the type of registration data collected by a hair salon will likely differ from the type registration data collected by an automotive repair shop.

A notification module 218 transmits a notification, as indicated by reference character 220 (i.e. notification 135), to the telecommunication device 106 of customer 112 when a table is available in response to a received notification request 134 generated at the work station computer 130. The notification request 134 comprises an identification of the customer 112 to be seated. The notification 220 can be a predefined text message or any other electronic communication message (e.g., e-mail) that informs the customer 112 that seating is, or will be available within a short period of time. The text message may include a link that corresponds to a telephone number of the restaurant such that customer 112 can initiate a phone call to verify the availability of the table. Alternatively, the notification 220 can be a pre-recorded voice message that is delivered via an automated telephone call to inform the customer 112 that the desired service is available or will available within a short period of time.

A transfer module 222 automatically transfers registration data to the central database 126 located on the server 104 at predetermined intervals. According to another aspect, the transfer module 222 transfers registration data 120 to the central database 126 in response to a transfer request received, indicated as by 224, from a member of the commissioning entity via the server application 122.

FIG. 3A illustrates an exemplary method for collecting registration data from a customer 112 in a mobile notification system implemented in a restaurant environment. At step 302, a start form 204 is shown on the display 116 of the client computer 102. The start form 204 may highlight special offerings 330 of the day or some other attraction (FIG. 3B). After a customer 112 selects a start option displayed on the start form 204, a party size entry form 206 is shown on the display 116 at step 304. The party size entry form 206 may also allow the customer 112 to answer optional questions such as whether he or she has a smoking or non-smoking section preference, or how many children are in the party at step 306. After the customer 112 enters the number of people in the party size entry form 206 and selects a next option displayed on the party size entry form 206, a customer name entry form 208 is shown on the display 116 at step 308. At step 310, after the customer 112 enters his or her name and selects a next option displayed on the customer name entry form 208, a telephone number entry form 210 is shown on the display 116. After the customer 112 enters his or her telephone number and selects a next option is displayed on the telephone number entry form 210, a telephone provider entry form 212 is shown on the display 116 at optional step 312. At step 314, the customer 112 is presented with a survey participation request form 352 (FIG. 3C). The survey participation request form 352 allows the customer 112 to indicate whether he or she is willing to participate in a brief survey in exchange for an incentive award such as a coupon, free desert, etc. According to another aspect, the survey participation request form is integrated into a message form that indicates registration is complete (e.g., see form 244 in FIG. 2N). If the customer 112 selects a “NO” option displayed on the survey participation request form 352, the registration process is complete, and the customer 112 will be notified via his or her mobile phone when a table is available at step 316. If the customer 112 selects a “YES” option displayed on the survey participation request form, the customer 112 is presented with a survey form (e.g., see survey forms 246-248 in FIGS. 2O-2P) that includes one more questions at step 318. After the customer 112 answers the survey questions, the registration process is complete, and the customer 112 will be notified via his or her mobile phone when a table is available at step 316.

At alternative step 320, a repeat customer 112 calls or sends a text message to the restaurant to reserve a table. The local administrator 132 collects information such as the number of people in the party and registers the repeat customer 112 for mobile notification via a workstation 130 at step 322. The local administrator 132 collects or hostesses may collect additional information such as a smoking or non-smoking section preference or number of children in the party at alternative step 324. If the repeat customer 112 arrives early to the restaurant, he or she can interact with the client computer 102 to view a survey participation request form (see FIG. 3C) such as described in step 312 above.

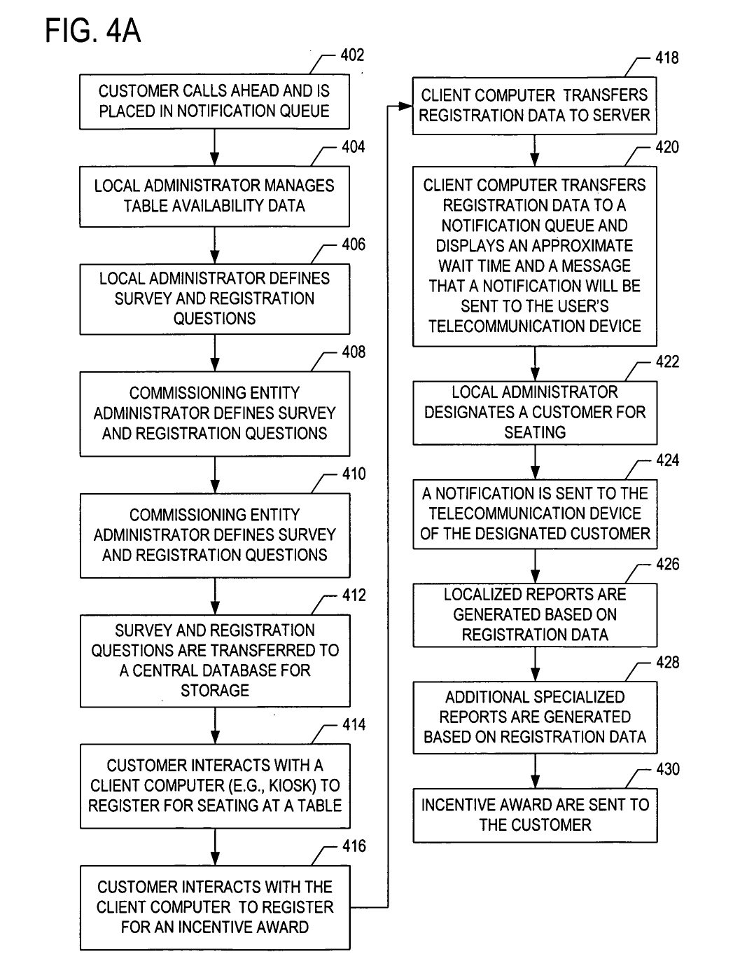

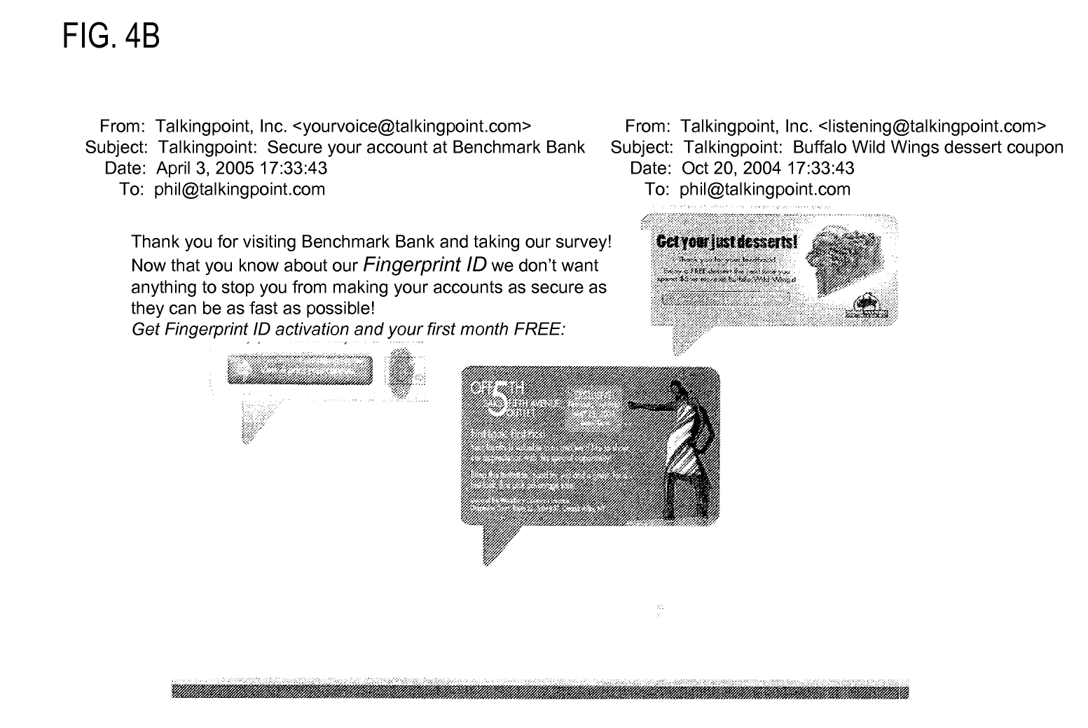

FIG. 4A illustrates a method for implementing mobile notification and satisfaction reporting via a mobile notification system for seating at a restaurant. In this example, a customer 112 calls ahead and is placed in the notification queue 150 via a host management system (e.g., work station 130) at step 402. A manager or local administrator 132 collects, monitors, and controls service availability data at step 404. At step 406, the manager can also define a survey and questions that can be presented to customers 112 via the client computer 102. An administrator 128 of a commissioning entity (e.g., corporate marketing) may also define survey and registration questions that can be presented to customers 112 via the client computer 102 at step 408. The defined survey and registration questions are transferred to a database 126 maintained by a server (e.g., 104) at step 410. At step 412, the survey and registration questions 408 are transferred from the server 104 to the client computer 102 (e.g., a kiosk).

A customer 112 interacts with the client computer 102 to register for a table at step 414. Optionally, the customer 112 interacts with the client computer 102 to register for a table and for incentive award by completing opt-in survey at alternative step 416. The client computer 102 transfers any collected registration data 127 to the server 104 at step 418. At step 420, the client computer 102 adds the customer 112 to a notification queue 150 that displays an approximate wait time to customer 112, and displays a message that indicates a notification will be delivered to the customer's telecommunication device 106. While waiting for the notification, the customer 112 can visit local shops. After a table becomes available, and the local administrator 132 or host can designate a customer 112 to be seated based on party size and the customer's order in the notification queue 150 at step 422. At step 424, a notification including a table ready message is sent to the telecommunication device 106 of the designated customer.

At step 426, localized reports are generated. For example, restaurant level reports that indicate volume, average wait time, average party size, etc. can be reviewed by the restaurant manager. Additional aggregated reports can be generated based on region, state, mall, etc. for review by representatives (e.g., corporate marketing) of the commissioning entity at step 428. At step 430, follow-up offers or incentive sent to the customer 112 via e-mail (see FIG. 4B), mobile phone (voice or text), or any other channel of communication. Customer 112 receives incentive, and, thus, encouraged to return to the restaurant to take advantage of incentive or special offer.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. A system for registering a user to receive a notification of an available service via a telecommunication device, said system comprising:
a client computer for use by the user to generate at least one input form for display, the at least one input form configured to receive registration data from the user, the registration data comprising a telephone number for the telecommunication device;
a host computer comprising an client application executable on the host computer, the client application comprising:
a storage module to receive the registration data from the client computer and to store the registration data in a local database;
a queue module to add the user to a notification queue, the notification queue listing one or more users in a sequence based on an order in which corresponding registration data was received at the local database; and
a notification module to identify a particular user in the notification queue to notify based on the corresponding registration data, to initiate communication with the particular user at the telecommunication device via a corresponding telephone number, and to send the notification to the particular user via the telecommunication device in response to a notification request, the notification request identifying the availability of a desired service.

2. The system of claim 1 wherein the client computer is further configured to generate at least one other input form for display, and wherein the at least one other input form is configured to receive registration data selected from a group consisting of a name, a number of people to receive the service, a telephone provider name, an e-mail address, and survey information.

3. The system of claim 2 wherein the at least one input form comprises a telephone entry form and wherein the at least one other input form is selected from a group consisting of a party size entry form, a customer name entry form, a telephone provider entry form, a survey participation request form, and an e-mail address entry form.

4. The system of claim 1 wherein the notification module automatically identifies the particular user to notify based on the corresponding registration data in response to the notification request.

5. The system of claim 1 wherein the host computer is responsive to input from a local administrator to generate the notification request.

6. The system of claim 5 wherein the notification request comprises an identification of a designated user to notify, and wherein the notification module sends the notification to the designated user.

7. The system of claim 1 wherein the client application is configured to transfer the registration data to a server computer for storage.

8. The system of claim 1 further comprising a server computer comprising a central database, and wherein the client application further comprises a transfer module to transfer the registration data from the local database to the central database for storage.

9. The system of claim 8 wherein the transfer module is configured to:
transfer the registration data to the central database at predetermined intervals; or
transfer the registration data to the central database in response to a transfer request generated by an administrator of the server computer.

10. The system of claim 1 wherein the notification is selected from a group consisting of a text message, an e-mail message, and a telephone call.

11. A system for registering a user to receive a notification of an available service via a telecommunication device, said system comprising:
a client computer comprising an client application executable on the client computer, the client application comprising:
a user interface module to generate at least one input form for display, the at least one input form configured to receive registration data from the user, the registration data identifying a telephone number for the telecommunication device;
a storage module to store the registration data received from the user in a local database;
a queue module to add the received registration data to a notification queue, the notification queue listing one or more users in a sequence based on an order in which corresponding registration data was received at the local database; and
a notification module to identify a particular user in the notification queue to notify based on the corresponding registration data, to initiate communication with the particular user at the telecommunication device via a corresponding telephone number, and to send the notification to the particular user via the telecommunication device in response to a notification request, the notification request identifying the availability of a desired service; and
another client computer for use by a local administrator to view the registration data in the notification queue and generate the notification request.

12. The system of claim 11 wherein the user interface module is further configured to generate at least one other input form for display, the at least one other input form is configured to receive other registration data selected from a group consisting of a name, a number of people to receive the service, a telephone provider name, an e-mail address, and survey information, and wherein:
the at least one input form is a telephone number entry form; and
the at least one other input form is selected from a group consisting of a party size entry form, a customer name entry form, a telephone provider entry form, a survey participation request form, and an e-mail address entry form.

13. The system of claim 11 wherein the notification module automatically identifies the particular user to notify based on the corresponding registration data in response to the notification request.

14. The system of claim 11 wherein the notification request comprises an identification of a designated user to notify, and wherein the notification module sends the notification to the designated user.

15. The system of claim 11 wherein the other client computer is configured to generate a queue request in response to input from the local administrator, and wherein the client application further comprises a transfer module to transfer the registration data from the notification queue to the other client computer for display in response to the queue request.

16. The system of claim 15 further comprising a server computer comprising a central database, and wherein the transfer module is configured to transfer the registration data from the local database to the central database for storage.

17. The system of claim 16 wherein the transfer module is configured to:
transfer the registration data to the central database at predetermined intervals; or
transfer the registration data to the central database in response to a transfer request generated by an administrator of the server computer.

18. A system for registering a user to receive a notification of an available service via a telecommunication device, said system comprising:
a client computer comprising an client application executable on the client computer, the client application comprising:
a user interface module to generate at least one input form for display, the at least one input form configured to receive registration data from a local administrator, the registration data comprising a telephone number for the telecommunication device of the user;
a storage module to store the registration data received from the user in a local database;
a queue module to add the user to a notification queue, the notification queue listing one or more users in a sequence based on an order in which corresponding registration data was received at the local database; and
a notification module to identify a particular user in the notification queue to notify based on the corresponding registration data, to initiate communication with the particular user at the telecommunication device via a corresponding telephone number, and to send the notification to the particular user via the telecommunication device in response to a notification request, the notification request generated in response to input from the local administrator identifying the availability of a desired service.

19. A method for registering a user to receive a notification of an available service via a telecommunication device, said system comprising:
generating at least one input form for display at a client computer, the at least one input form configured to receive registration data from the user, the registration data identifying a telephone number for the telecommunication device;
storing the registration data received from the user in a local database;
adding the user to a notification queue, the notification queue listing one or more users in a sequence based on an order in which corresponding registration data was added to the local database;
identifying a particular user in the notification queue to notify based on the corresponding registration data;
initiating communication with the particular user at the telecommunication device via a corresponding telephone number; and
sending the notification to the particular user via the telecommunication device in response to a notification request, the notification request identifying the availability of a desired service.

20. The method of claim 19 wherein the at least one input form is a telephone number entry form.

21. The method of claim 19 further comprising:
generating at least one other input form for display; and
receiving, at the at least one other input form, registration data for the user selected from a group consisting of a name, a number of people to receive the service, a telephone provider name, an e-mail address, and survey information.

22. The method of claim 21 wherein the at least one other input form is selected from a group consisting of a party size entry form, a customer name entry form, a telephone provider entry form, a survey participation request form, and an e-mail address entry form.

23. The method of claim 19 comprising automatically identifying the particular user to notify based on corresponding registration data in response to the notification request.

24. The method of claim 19 further comprising transferring the registration data from the notification queue to the other client computer for display in response to a queue request received from the local administrator.

25. The method of claim 24 further comprising transferring the registration data from the local database to a central database of a server computer for storage, wherein the transferring comprises:
transferring the registration data to the central database at predetermined intervals; or
transferring the registration data to the central database in response to a transfer request generated by an administrator of the server computer.
